(19) United States
(12) Patent Application Publication
(10) Pub. No.: US 2005/0253818 A1
(43) Pub. Date: Nov. 17, 2005

(54) Method of interpreting control command, and portable electronic device

(76) Inventor: Esa Nettamo, Oulu (SE)

Correspondence Address: Hollingsworth & Funk, LLC, Suite 125, 8009 34th Avenue South, Minneapolis, MN, 55425, US

(21) Appl. No.: 10/518,807

(22) PCT Filed: Jun. 18, 2003
(86) PCT No.: PCT/FI03/00497

§ 371 Date: Dec. 21, 2004

(30) Foreign Application Priority Data
Jun. 25, 2002 (FI) 20021239

(51) Int. Cl. G09G 5/00

(52) U.S. Cl. 345/173

(57) ABSTRACT

The invention relates to a method of interpreting a control command given on a touch screen of a portable electronic device, in which method the combination of a touch on an area interpreted as a contact area and a release of the touch from the area interpreted as said same contact area is interpreted as a control command. The method comprises interpreting, once the contact area has been touched, a larger contact area as said same contact area for the release of the touch than the contact area before the touch.

### FIELD

The invention relates to a portable electronic device and a method of interpreting a control command. The invention relates to a portable electronic device including a touch screen and to a method of interpreting a control command in a device including a touch screen.

### BACKGROUND

In prior art portable electronic devices, touch screens are used to replace the mouse and the keypad, for example. The user issues control commands to the device by touching objects visible on the touch screen. The device interprets a touch on an area interpreted as a contact area and the release of the touch from the same area interpreted as a contact area as a control command. The contact areas are usually touched by means of a pen or a finger.

Prior art portable electronic devices are often small and it is hard to accurately hit the objects visible on the touch screens of the devices. Giving control commands by means of a touch screen in a moving vehicle, for example, is tedious, since the accuracy of the hit impairs as the hand or pen shakes. The slippery surface of the tip of a pen also complicates hitting the desired contact areas on a touch screen. It is usual that when touching a contact area on a touch screen with a pen, for example, the pen glides a considerable distance from the contact point before the touch is released. If the point of release of the touch happens to be in a different contact area than the one the touch originally was directed to, the control command is not interpreted as completed and the user has to retry to give the control command. Since it is tedious to give control commands, large contact areas have to be used, which again makes the use of a touch screen difficult, since only a few large objects fit the touch screen simultaneously.

### BRIEF DESCRIPTION

An object of the invention is to provide a method and a device for implementing the method so as to alleviate prior art problems. This is achieved by a method of interpreting a control command given on a touch screen of a portable electronic device, in which method the combination of a touch on an area interpreted as a contact area and a release of the touch from the area interpreted as said same contact area is interpreted as a control command. The method of the invention comprises: interpreting, once a contact area has been touched, a larger contact area as said same contact area for the release of the touch than the contact area before the touch.

The invention also relates to a portable electronic device comprising a touch screen having a plurality of contact areas, and a control unit for interpreting control commands given on the touch screen, in which device the combination of a touch on an area interpreted as a contact area and a release of the touch from the area interpreted as said same contact area is interpreted as a control command. In the device of the invention, once the contact area has been touched, the control unit is configured to interpret a larger contact area as said same contact area for the release of the touch than the contact area before the touch.

The preferred embodiments of the invention are described in the dependent claims.

The method and device of the invention provide a plurality of advantages. The accuracy of giving control commands increases. Smaller contact areas may be used, whereby more objects fit onto the touch screen. In addition, the user friendliness of the device improves and the device is also easier to use under difficult conditions, such as in moving vehicles.

### LIST OF THE FIGURES

In the following, the invention will be described in detail in connection with preferred embodiments with reference to the accompanying drawings, in which

FIGS. 1A and 1B show devices of the invention,

FIGS. 2A and 2B show details of the touch screen of a device of the invention, and

FIG. 3 shows details of the touch screen of a device of the invention.

### DESCRIPTION OF THE EMBODIMENTS

The invention is applicable in portable electronic devices, such as a mobile station used as a terminal in telecommunication systems comprising one or more base stations and terminals communicating with the base stations. In some embodiments of the invention, the device includes means for short-range communication, such as a transceiver function implemented with a Bluetooth chip, an infrared or WLAN connection, for example. The portable electronic device is e.g. a mobile telephone or another device including telecommunication means, such as a portable computer, a handheld computer or a smart telephone. The application is also applicable in PDA (Personal Digital Assistant) devices including the necessary telecommunication means, or in PDA devices that can be coupled to a mobile telephone, for instance, for a network connection. The portable electronic device may also be a computer or PDA device not including telecommunication means.

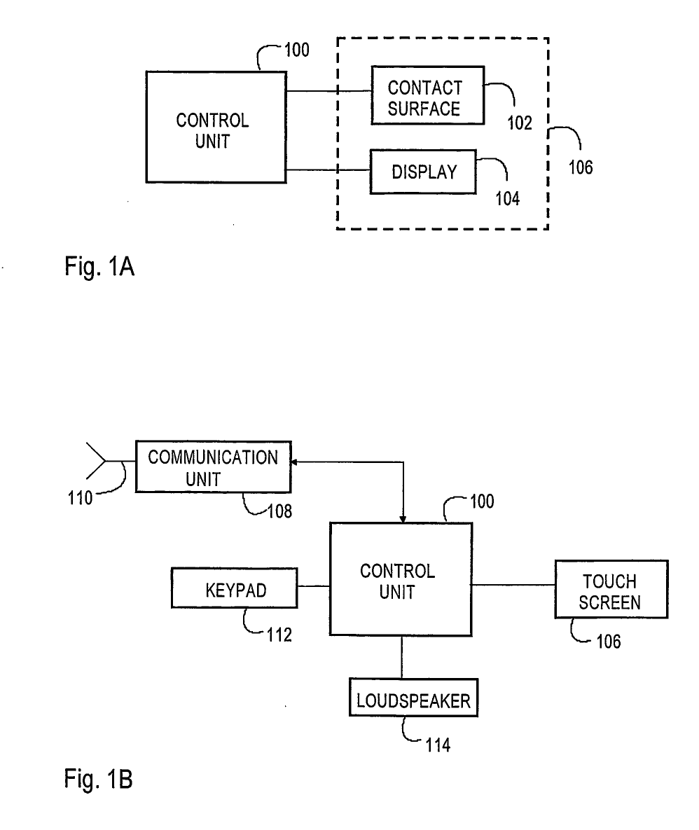

FIG. 1A shows a block diagram of the structure of a portable electronic device. The basic functions of the device are controlled by a control unit 100, typically implemented by means of a microprocessor and software or separate components. The user interface of the device comprises a display 104 and a contact surface 102, which together form a touch screen 106. An alternative is to have only a contact surface 102 and no display 104 at all. In the touch screen 106, the contact surface 102 is on top of the display 104. An alternative way to implement the touch screen is not to actually place anything on top of the display 104, but to indicate the contact point by other means, such as capacitively or acoustically. Typically, the display 104 is a liquid crystal display.

A way to implement the contact surface 102 is based on two overlapping transparent films and continuous electric current, which is generated between the films when the outer film is pressed with a finger or another object against the lower film, which is covered with a resistive layer. The contact surface 102 may also be implemented capacitively, whereby the surface is covered with an electrically conducting layer, over which an alternating current acts. The capacitance of the human body couples part of the voltage at the contact point to ground, allowing the voltage to be measured. The contact surface 102 can also be implemented acoustically based on ultrasonic waves traversing the surface of the display. When the display is touched, the sonic wave traversing the surface is attenuated, and the change can be measured. Infrared light may also be used instead of sonic waves. It is also feasible to implement the contact surface 102 by means of power sensors or a projector and cameras. In principle, the contact surface 102 may be any surface on which an image is reflected with a projector and a camera is used to detect the point where the projected image was touched.

FIG. 1B is a block diagram of the structure of an electronic device. All basic functions of the device, including the keypad and the touch screen functions, are controlled by the control unit 100, typically implemented by means of a microprocessor and software or separate components. The user interface of the device comprises a touch screen 106, which, as mentioned, is the whole formed by the contact surface 102 and the display 104 shown in FIG. 1A. In addition, the user interface of the device may include a loudspeaker 114 and a keypad part 112. Depending on the type of device, there may be different and a different number of user interface parts. The device of FIG. 1B, such as a mobile station, also includes conventional means 108 that implement the functions of a mobile station and include speech and channel coders, modulators and RF parts. The device also comprises an antenna 110.

The device is controlled by means of the touch screen 106 such that the desired selections are made by touching the desired contact area visible on the touch screen 106 and by releasing the touch from said same contact area. A control command given to the device is the combination of a touch on an area interpreted as a contact area and a release of the touch from the area interpreted as the same contact area. The touch is carried out by means of a pen or a finger, for example. In order for the control unit 100 of the device to interpret the touch and the release of the touch as a control command, said functions are to be executed in an area interpreted as the same contact area. For example, if a contact area interpreted as a contact area is touched and the touch is released in a contact area interpreted as another contact area, the control unit 100 does not interpret it as a control command.

In an embodiment of the invention, the control unit 100 detects a touch on a contact area on the touch screen 106, and as a result, the control unit 100 interprets a larger area than the contact area covered before the touch as the same contact area for the release of the touch. In practice, a touch on a contact area interpreted as a contact area results in that the software in the memory of the control unit detects it as a contact area, and, as a result, the area interpreted as the same contact area is expanded. When the touch is released from the touch screen 106, the control unit 100 interprets the release of the touch to have occurred in a larger contact area than what the contact area was before the touch. Consequently, the touch does not necessarily have to be released in the contact area that was interpreted as a contact area before the touch. On the other hand, if the touch is released outside the larger area, interpreted as the same contact area, the control command fails.

The larger contact area, interpreted as the same contact area for the release of the touch, includes, not only the contact area that was interpreted as the contact area before the touch, but also part of the area surrounding the contact area for the touch. Thus, the distance between the touch and the release of the touch for the control command can be longer than in prior art solutions, where the contact area is not expanded for the release of the touch, which also helps the user in giving a control command. The fact how much the contact area is expanded for the release after the touch depends on settings made by the user or the manufacturer of the device, for example. The larger contact area for the release of the touch includes, not only the contact area for the touch, but also part of the area surrounding the contact area for the touch. The additional area created by the expanded contact area is for instance an equally large area surrounding the contact area in every direction. The larger contact area is for instance 25% larger than the area interpreted as the contact area before the touch. If the contact area is located for instance at the edge or corner of the touch screen 106, the additional area created by the larger contact area is only in the directions where the edges of the touch screen 106 are not in the way. Not only the edges, but also other active areas on the touch screen 106, such as an Internet window, may prevent the expansion.

In an embodiment of the invention, a function may be programmed, as a result of which a light signal is given once the control unit 100 detects a touch on a contact area. Said light signal lights up the contact area and remains on to indicate that the touch stays in the area interpreted as the contact area also when the touch moves to a larger contact area before it is released. On the other hand, if the contact point moves, after the contact area is touched, outside the area interpreted as the contact area for the release, the light signal goes out to indicate that the contact point is outside the area interpreted as the contact area. In an embodiment of the invention, the user may select other signals than a light signal to indicate for instance that the touch remains in the area interpreted as a contact area. Such a signal may be a sound signal, for example. Signalling may also be incorporated as part of the different user profiles of the device specified by the user, and for example in such a manner that in a given user profile, a sound signal is given as the result of a touch on a contact area, and in some other user profile, a light signal is given to indicate a correct touch.

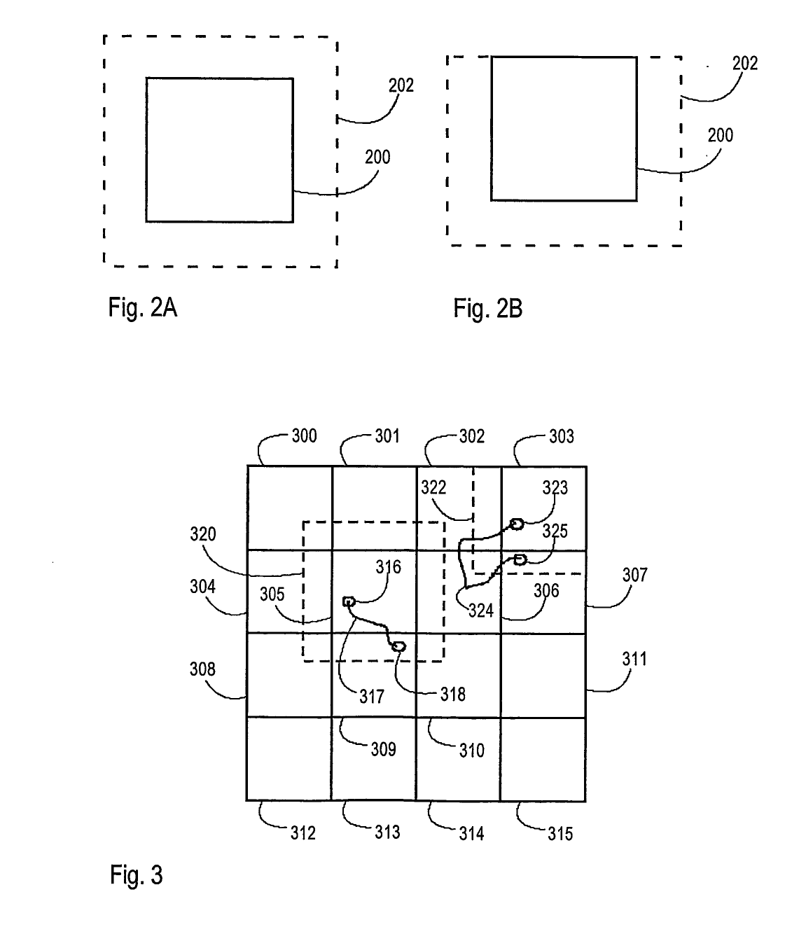

Let us next study the examples of FIGS. 2A and 2B. FIGS. 2A and 2B show a contact area 200 on a touch screen. There are a desired number of contact areas on a touch screen. A touch on a contact area 200 and a release of the touch on said same contact area results in software functions associated with said contact area 200 in the control unit of the device. When a contact area 200 is touched, the control unit interprets a larger contact area 202 than the contact area 200 as such a contact area from which the touch is to be released. In FIGS. 2A and 2B, the larger contact area 202 is shown by broken lines. When the user of a device comprising a touch screen touches the contact area 200 in situations according to FIGS. 2A and 2B, the touch can be released in the larger contact area 202 for instance such that the point of release is not at all in the area of the contact area 200 for the touch.

In the example of FIG. 2A, the larger contact area 202 for the release surrounds the contact area 200 and extends equally far in every direction relative to the borders of the contact area 200. In FIG. 2B, the larger contact area 202 includes, not only the contact area 200, but also an expansion starting from the lower edge and sides of the contact area 200. The larger contact area 202 may also include less area on the side of the upper edge of the contact area 200 than on the side of the lower edge of the contact area 200 such that the expansion does not extend equally far in every direction.

Let us study the example of FIG. 3 of a solution of the invention. FIG. 3 shows contact areas 300 to 315 on a touch screen, larger contact areas 320 and 322 for the release, illustrated by broken lines, contact points 316 and 323 touched on the touch screen, a touch path 317 and 324 after the contact points 316, 323, and touch release points 318 and 325. When the user wants to give control commands to the device, he touches the desired contact areas 300 to 315 and tries to release the touch in the contact area interpreted as the same where the touch began.

In the example of FIG. 3, the user wants the device to carry out given functions and to accomplish this, has to give a control command in contact area 305. The user initiates the control command by touching contact area 305. The touch hits contact point 316 in contact area 305. Contact point 316 is within the contact area 305 desired by the user, and as a sign for the user a signal light, for example, could be lit in contact area 305. When the user has touched contact area 305, the control unit interprets the larger contact area 320, outlined by broken lines, as the same contact area for the release. In order for the control command to succeed, the user has to release the touch in the area inside said larger contact area 320. Before the touch is released, the pen or finger of the user glides on the surface of the touch screen along the touch path 317. The user releases the touch at touch release point 318, which is within the borders of the larger contact area 320. Since touch release point 318 is in the contact area that is interpreted as the same as the one where contact point 316 was located, the control command succeeds. If the device did not interpret the larger contact area as the contact area, the release point would then be in the wrong contact area 309 and the control command would fail.

Next, in the example of FIG. 3, the user wants to give a control command in contact area 303. As previously, the user starts executing the control command by touching said contact area 303. The touch hits contact area 303 at contact point 323. The device now interprets the larger contact area 322, outlined by broken lines, as said same contact area, from which the touch has to be released in order for the control command to succeed. However, before the touch is released, the pen or finger of the user glides on the surface of the touch screen along the touch path 324. The touch path 324 partly extends outside the larger contact area 322. However, the user releases the touch at release point 325, which is located in the larger contact area, interpreted as the same contact area that the touch hit. The control command again succeeds, although during its execution the pen or finger was outside the larger contact area for the release of the touch. If a light signal is lit as a sign of a touch on contact area 303, it may have gone out when the user's pen or finger was outside the area 322 interpreted as a contact area. When the user then corrects the movement, for instance alarmed by the light signal going out, the light signal is again lit as a sign of the return to the larger contact area 322 for the release.

Although the invention is described above with reference to examples according to the accompanying drawings, it is apparent that the invention is not limited thereto, but can be modified in a variety of ways within the scope of the inventive idea disclosed in the attached claims.

1. A method of interpreting a control command given on a touch screen of a portable electronic device, in which method the combination of a touch on an area interpreted as a contact area and a release of the touch from the area interpreted as said same contact area is interpreted as a control command, the method comprising interpreting, once the contact area has been touched, a larger contact area as said same contact area for the release of the touch than the contact area before the touch.

2. A method as claimed in claim 1, wherein the larger contact area for the release of the touch including, not only the contact area for the touch, but also part of the area adjacent to the contact area.

3. A method as claimed in claim 1, the method comprising interpreting the larger contact area for the release of the touch to include, not only the contact area for the touch, but also an expansion of the contact area for the touch in each free direction.

4. A method as claimed in claim 3, the method comprising interpreting the larger contact area for the release of the touch to include, not only the contact are a for the touch, but also an equally large expansion of the contact area for the touch in each free direction.

5. A method as claimed in claim 1, wherein the larger contact area for the release of the touch being at least 25 percent larger than the contact area for the touch.

6. A method as claimed in claim 1, the method comprising performing signalling once the contact area has been touched.

7. A method as claimed in claim 6, wherein said signalling being a light, voice or vibration signal.

8. A method as claimed in claim 6, the method comprising continuing the signalling as long as the touch remains in the area that is interpreted as the contact area and that was touched.

9. A portable electronic device comprising a touch screen having a plurality of contacts areas and a control unit for interpreting control commands given on the touch screen, in which device the combination of a touch on an area interpreted as a contact area and a release of the touch from the area interpreted as said same contact area is interpreted as a control command, wherein once the contact area has been touched, the control unit is configured to interpret a larger contact area as said same contact area for the release of the touch than the contact area before the touch.

10. A device as claimed in claim 9, wherein the control unit is configured to interpret the larger contact area for the release of the touch including, not only the contact area for the touch, but also part of the area adjacent to the contact area.

11. A device as claimed in claim 9, wherein the control unit is configured to interpret the larger contact area for the release of the touch to include, not only the contact area for the touch, but also an equally large expansion of the contact area for the touch in each free direction.

12. A device as claimed in claim 9, wherein the control unit is configured to interpret the larger contact area for the release of the touch to be at least 25 percent larger than the contact area for the touch.

13. A device as claimed in claim 9, wherein the device includes means for performing signalling once the contact area has been touched.

14. A device as claimed in claim 13, wherein said signalling is a light, voice or vibration signal.

15. A device as claimed in claim 13, wherein the device includes means for continuing the signalling until the touch remains in the area that is interpreted as the contact area and that was touched.

16. A device as claimed in claim 9, wherein the portable electronic device is a mobile station.

17. A device as claimed in claim 9, wherein the portable electronic device is a PDA (Personal Digital Assistant) device or a portable computer.

18. A device as claimed in claim 17, wherein the device comprises means for establishing a telecommunication connection or a short-range wireless connection.

19. A device as claimed in claim 18, wherein the telecommunication connection is an Internet connection.

20. A device as claimed in claim 18, wherein the short-range wireless connection is a Bluetooth, infrared or WLAN connection.
